(19) United States
(12) Patent Application Publication
(10) Pub. No.: US 2004/0258287 A1
(43) Pub. Date: Dec. 23, 2004

(54) Method and system for configuring a scanning device without a graphical user interface

(76) Inventor: Gregory A. Gustafson, Independence, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/871,740

(22) Filed: Jun. 17, 2004

Related U.S. Application Data
(60) Provisional application No. 60/480,691, filed on Jun. 23, 2003.

(51) Int. Cl. G06K 9/00; G06F 17/00

(52) U.S. Cl. 382/128

(57) ABSTRACT

A method and system for configuring a mammography diagnostic system without the use of a graphical user interface. In one embodiment, the system includes a scannable report preference form having user-configurable parameters, and an arrangement for reading the marks on the scannable preference form. The user-configurable parameters are selectable by placing a mark on the scannable preference form.

### FIELD OF THE INVENTION

The invention relates to digital data processing systems and methods for optically reading and processing data for visual review and presentation. In particular, the invention relates to configuring medical information systems for a particular user.

### BACKGROUND OF THE INVENTION

Historically, interpretation and diagnosis of mammograms and other medical images has been performed using hardcopy x-ray films viewed on an alternator, which has to be manually loaded and unloaded. Alternators typically only allow an x-ray film to be illuminated and masked to block out unwanted light. Any additional means for assisting interpretation, such as using a magnifying device, ruler, and/or hot light to differentiate areas on an image that are difficult to read often requires an awkward or inconvenient manual process by a radiologist, thereby preventing him or her from using his or her hands to perform other tasks such as creating reports concurrently with interpretation. Use of the hot light also necessitates that an image be removed and reinserted onto the alternator. This excessive handling of x-ray films or other images is inefficient and can lead to mix-ups, misplacements, or other mishandlings of patient studies.

These problems have begun to be addressed with recent advances in computer technology. Computer hardware such as processors, video boards, and networks are much faster so that it is now possible to process the large volumes of data flow needed for distributing, manipulating, and viewing graphical images, and reasonably priced, high resolution color and grayscale liquid crystal displays (LCDs) are commercially available. In addition, new tools and libraries are available for more powerful applications, such as computer aided detection (CAD) software and Picture Archiving Communication Systems (PACS). Further, standards have been implemented so that products are more integrable or useful together. With these advances, the medical profession is increasingly using digitized x-rays in mammography as the preferred means for interpretation and diagnosis, and the Federal Drug Administration has recently approved using digital mammography softcopy systems without requiring accompanying hard copy images. As a consequence of this increased use of digitalized mammograms and computerized diagnostic software, early detection of breast disease has increased.

Some medical images are scanned into the medical information system via a scanner using optical reading techniques.

Optical mark recognition (OMR) systems and techniques for optically reading marks, characters, symbols or other information are currently known. Most such optical reading devices generally have an optical interface for receiving information and a processor for conditioning, processing and/or interpreting the received information, according to the particular type of data (i.e., mark, character, symbol, etc.) to be detected.

Optical mark readers are devices that are used for reading graphical marks on paper or other documents. Typically with optical mark readers, the relative locations of the marks or punchouts on a page indicate data, such as letters, digits, codes, or other such information. The marks may be made automatically by machine (e.g., a printer operating under computer control), or manually using a writing implement. Often the marks are made on a printed “form” document that has predefined boxes or other physical areas having a specific meaning attached to them. Examples of such printed form documents include standard form test sheets, voting ballots, and lottery tickets.

An optical mark reader detects the marks on a paper by measuring the amount of light reflected and/or refracted by the paper at specific locations. A white paper background reflects more light than a darker mark or void; thus an optical mark reader can detect a mark when the amount of light reflected and/or refracted from the paper is sufficiently low, and otherwise detects the absence of a mark.

Another type of optical reading is performed by optical character recognition (OCR) systems. In these systems, an optical detector captures a single line of data, isolates characters based upon relative contrast (i.e., low reflectance levels), and matches templates of alphanumeric characters to each isolated character in the line of data. An OCR system may repeat this process for each line of data read, and can thereby read and interpret the text on an entire document.

Once the medical image is scanned and is optimally “read” into the medical information system, the user can use a graphical user interface (GUI; e.g., mouse, keyboard, touch screen) to configure the medical information system to suit their needs. However, in some cases the scanner is received in a pre-configured state. Changing configurations requires a service representative visit because the settings are not externally accessible on the scanner or on the medical information system. Therefore, there is a need for a system that addresses the needs of the prior art.

### SUMMARY OF THE INVENTION

The invention facilitates configuration of the software and hardware of a medical information system using an OMR (Optical Mark Recognition) format or an OCR (Optical Character Recognition) format illustrated on a scannable document or form.

In an example embodiment of the invention, a facility preference form is used to facilitate the reconfiguration of the software and/or hardware of a scanning device by using OMR or OCR technology. In this example embodiment, the scanning device is programmed with CAD software and is connected to a printer. Before displaying the medical images and rendering an opinion, a radiologist can select one or more of a number of commands that include, but are not limited to, the scan order of the medical images, language for review and the report, the number of report copies, sounds for various viewing operations, the format of the results, date reminder for equipment calibration, their conservation, number of copies, and a flasher ID for various views.

In an example embodiment of the invention, selected marks placed on scannable preference forms are optically scanned. The selected marks are processed using an optical recognition program to generate data. The generated data is adapted to alter at least one default setting of a mammography diagnostic system.

In another example embodiment of the invention, scannable preference forms display user-configurable parameters, wherein the parameters can be selected by placing marks on the scannable preference forms.

In another embodiment, a preference report article includes optically-scannable marking fields on a form to provide user-selected preferences to alter hardware and software default settings.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is an example embodiment of a GUI (Graphical User Interface)-less medical information system in accordance with the invention;

FIGS. 2A and 2B illustrate facility preference forms that are scanned in for configuring a scanning device in accordance with the invention; and

FIGS. 3A-3G illustrate various bounding boxes for the facility preference forms and several examples of marked boxes for mark recognitions and erasure recognition.

FIG. 4 is an example of code used for mark recognition and erasure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

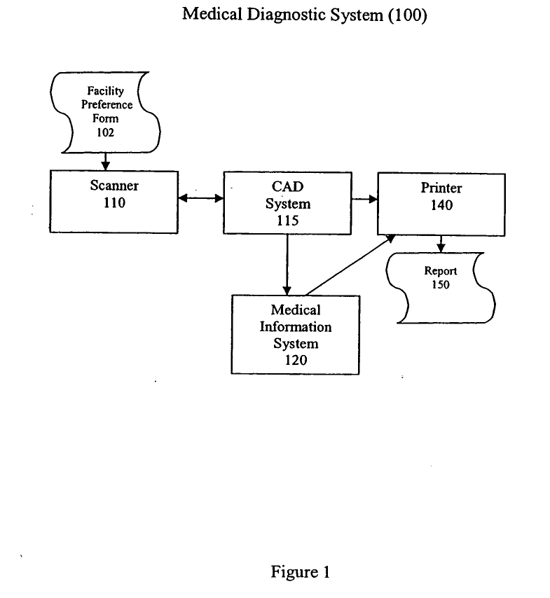

The invention can be understood by reference to FIGS. 1, 2A-2B and 3. FIG. 1 illustrates an example embodiment of a medical diagnostic system 100 that is configurable without a graphical user interface (GUI) in accordance with the invention. Medical diagnostic or detection system 100 comprises a scanning device 110 communicatively coupled to a computer aided detection (CAD) system 115 and a printer 140. System 100 is optionally coupled to a medical information system 120. Once the medical professional is finished using diagnostic system 100, a report 150 is generated via printer 140. Note from this system that there is no GUI that is available to the user for reconfiguring the software or hardware of system 100. In this example of a medical diagnostic system, scanning device 110 is pre-configured by the manufacturer before arriving to the medical facility with typical default settings normally used in a medical setting. However, under the present technology, where the radiologist or user wishes to change the configuration for his particular needs, a service representative must be called to reconfigure system 100 using some type of GUI (e.g., keyboard, mouse, touch screen monitor, wireless mouse or PDA, etc.) to suit the needs of that particular user.

The invention facilitates reconfiguration of system 100 in any number of ways for any number of users without the use of a GUI. This approach not only allows the user to reconfigure the hardware settings but also reconfigure the software settings to accommodate each user; with the invention a broad range of reconfigurations can be performed.

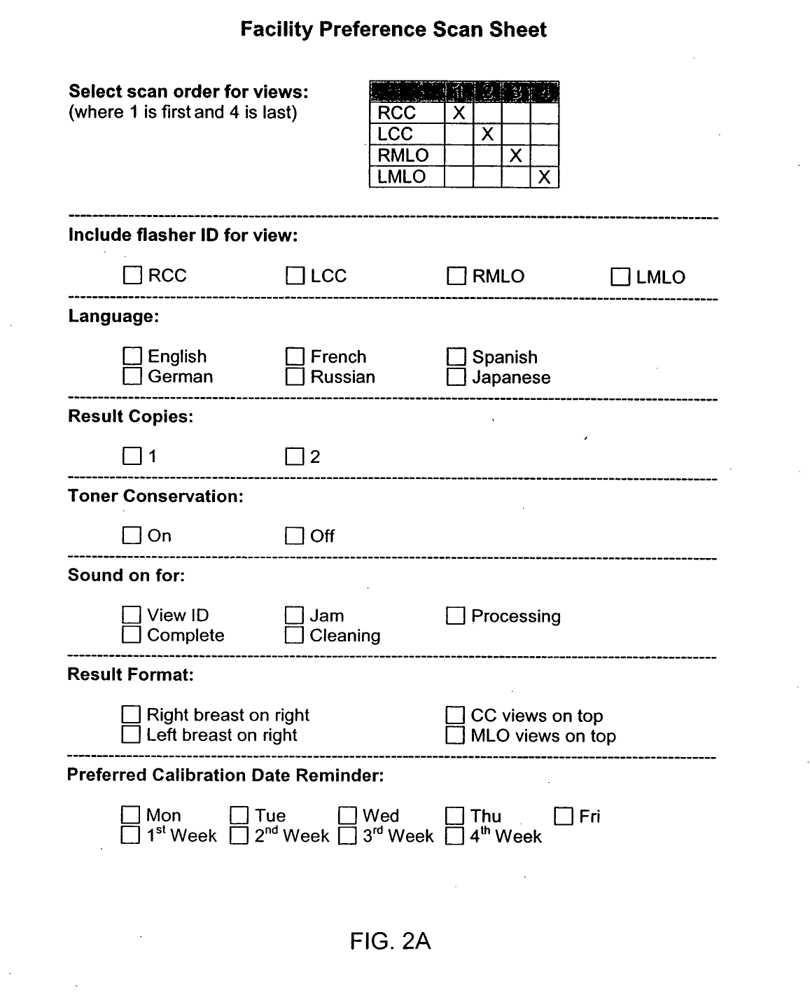

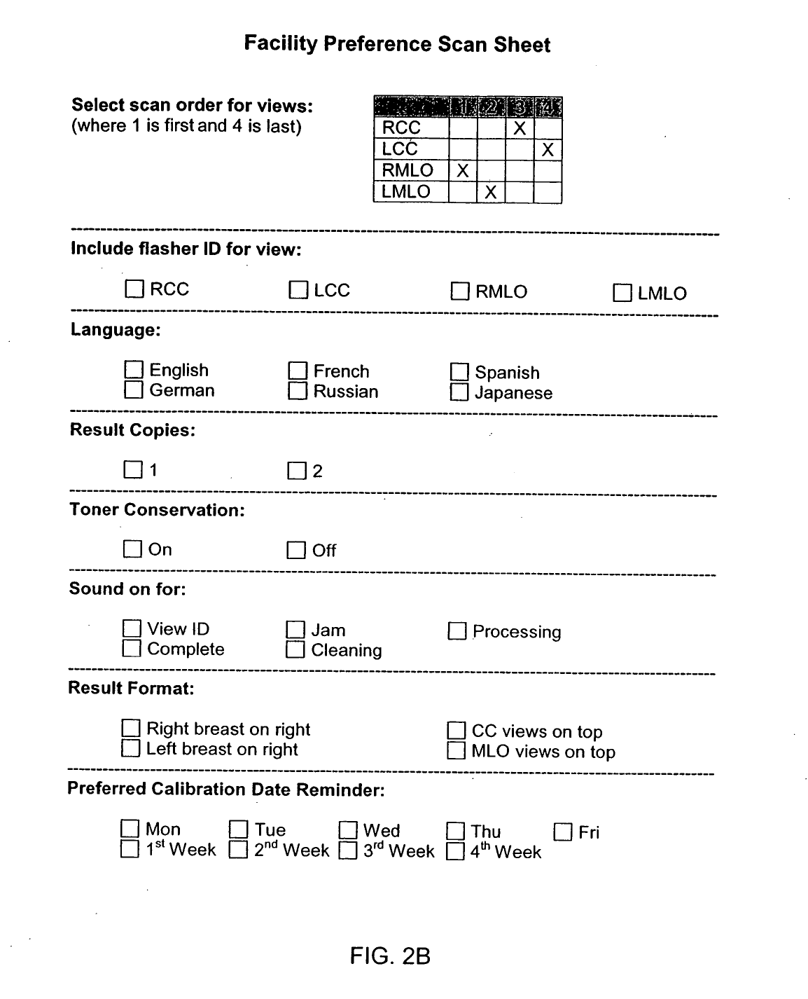

Referring back to FIG. 1 and to FIGS. 2A and 2B, a facility preference form 102, having at least one OCR (optical character recognition) or OMR (optical mark recognition) marking on its face, is filled out by placing a mark within the rectangular fields in each of the options that require change as indicated on the sheet. For example, in a mammography environment, 4 views of the breast are reviewed by the radiologist: RCC, LCC, RMLO and LMLO. If, for example the fields (of any geometric shape that can be marked to reduce the amount of light reflected back to the optical reader) are filled in diagonally going down and from left to right, as shown in FIG. 2A, the RCC view would come up first for review while the LMLO view would come up last (or fourth) for review. Another radiologist that wishes to change the order of review would simply fill out another form 102 (as illustrated in FIG. 2B) with his viewing order preference. FIG. 2B illustrates a different preference such that the RMLO, LMLO, RCC and LCC would appear in this order. In this example, one or two copies of the report can be requested.

Form 102 permits other software or hardware default settings to be altered depending on the user's preference without manufacturer or technical knowledge or intervention. For instance, the default language of a CAD system's 115 output is English, however other languages (as indicated can be selected). Other options include, but not limited to, the number of report copies, a toner conservation mode, selection of sounds for various operations, a result format and also a calibration date reminder prompt. Not all of the available options need be selected; only the ones that are of interest to a particular user. These forms also provide a visual recording of any of the system settings that have been altered and allows the transfer of these settings to any replacement systems without manufacturer or technical intervention.

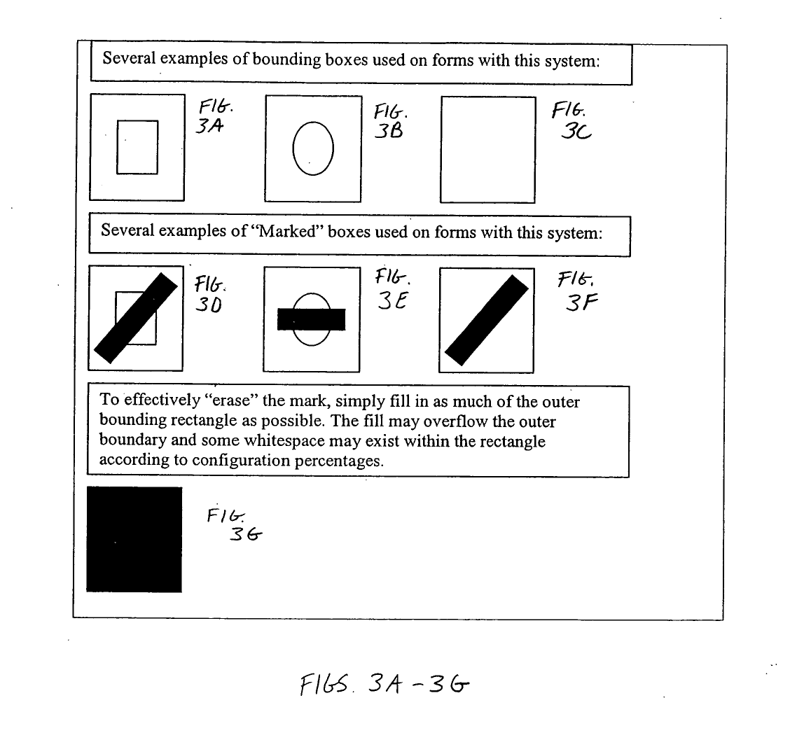

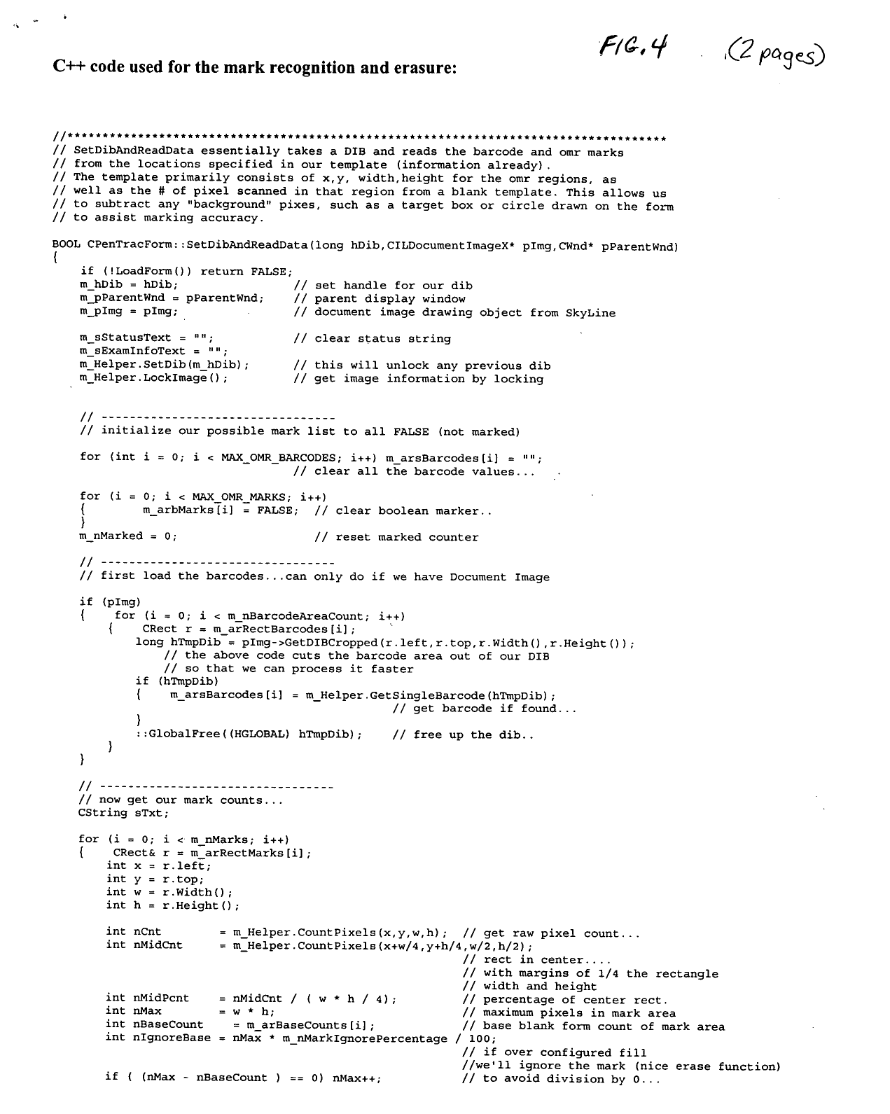

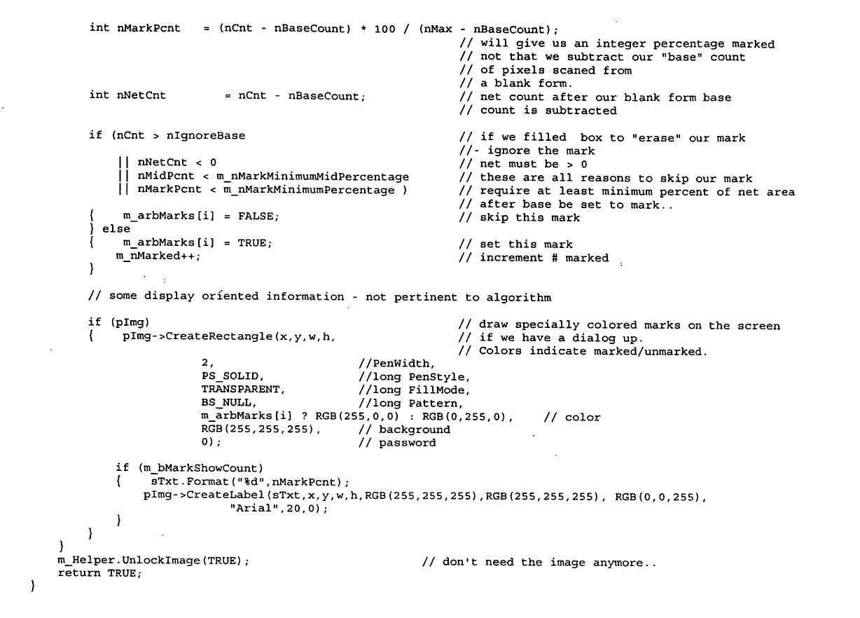

Referring to FIGS. 3A-3G, the facility preference form 102 can include a series of bounding (inner and outer) boxes (see FIGS. 3A-3C) defining inner and outer regions for marking. An example of code used for marking recognition and erasure of marks is illustrated in FIG. 4 (which carries over onto the next page). In order for a mark to be recognized by OCR or OMR scanning a certain percentage of pixels bounded by the inner box must be marked by a user (see FIGS. 3D-3F). If a user makes an error in their marking selection, the user may fill at least the entire area bounded between the inner and outer boxes to have the OCR or OMR register an erase and effectively ignore the selection original selection (see FIG. 3G). In one particular embodiment, the inner box is sized to have margins on all sides between its outer boundary and the boundary of the outer box. The margins on each side may be equal to one-quarter the corresponding dimension of the larger bounding box. As illustrated in FIG. 3, various shapes may be used for the inner and outer boxes (see FIGS. 3A-3C).

In operation, the user makes the selections on facility preference form 102 and then proceeds to insert form 102 into scanning device 110. Scanning device 110 optically reads the marking(s) and interprets them as commands to reconfigure the software and hardware settings of system 100 before the user begins to use system 100 for his analysis and report preparation. In one example embodiment, regular users can have form 102 pre-filled with their preferences and readily available in order that a technician or medical employee can prepare system 100 in advance of the user.

In another embodiment, the facility preference form 102 having inner and outer bounded boxes for marking may be scanned into the scanning device 110 to generate a baseline black pixel count for each mark bounding area. This information is stored in the system 100. When a completed form is scanned and the black pixels are counted for each mark region, the baseline black pixel count is subtracted prior to counting the pixels for the purpose of mark recognition. This allows the use of forms printed in black and white that may be printed on demand at a computer rather than using preprinted forms with the mark regions outlined in colors that can be ignored. When a certain predefined percentage of black pixels are detected the selection is entered into system 100. However, if a user makes an error in selecting a particular box, the user may fill in the bounding area defined by the outer box to have system 100 ignore the selection.

In a related embodiment, the preference form is applicable to other information systems that is accessed by various users but does not have a GUI for configuration so as to prevent users from inadvertently accessing certain software programs and settings that should not be altered. The invention provides for a method of performing minor reconfigurations of the information system without concern for corrupting the main software and hardware settings or programs. The teachings of the invention are applicable to configuring other data processing systems and are not necessary limited to the medical diagnostic and information systems described above nor limited to reconfiguring scanning devices. The preference form and scanner can also be used to reconfigure the software and hardware of other downstream devices in a medical information or data processing system.

In a related embodiment, a CAD system further comprising analysis software analyzes the images using the analysis software and produces a set of prompts that describes areas of interest. For further background information on OCR and OMR, reference is made to U.S. Pat. No. 6,176,429 to Reddersen et al., which is hereby incorporated by reference.

The invention may be embodied in other specific forms without departing from the essential attributes thereof, therefore, the illustrated embodiments should be considered in all respects as illustrative and not restrictive, reference being made to the appended claims rather than to the foregoing description to indicate the scope of the invention.

1. A method of configuring a mammography diagnostic system comprising the steps of:
optically-scanning at least one selected mark associated with at least one configurable parameter;
processing the at least one selected mark using an optical recognition program so as to generate output data; and
altering at least one default setting of the diagnostic system using the output data; wherein the mammography diagnostic system is configured without the use of a graphical user interface.

2. The method of claim 1, further comprising the step of providing at least one scannable preference form with at least one configurable parameter.

3. The method of claim 1, wherein the optically-scanned mark is read using an optical character recognition program.

4. The method of claim 1, wherein the optically-scanned mark is read using an optical mark recognition program.

5. The method of claim 1, further comprising the step of using a computer aided diagnostic program to analyze one or more mammographic images to generate one or more prompts to a user.

6. The method of claim 1, further comprising the step of printing a report after altering the at least one default settings.

7. The method of claim 1, wherein the at least one default settings are stored as data on a computer storage device.

8. The method of claim 1, further comprising a plurality of configurable parameters.

9. The method of claim 8, wherein the configurable parameters include an order of review of a plurality of scanned images.

10. The method of claim 8, wherein the configurable parameters include a desired number of report copies.

11. The method of claim 8, wherein the configurable parameters include format results.

12. The method of claim 8, wherein the configurable parameters include one or more date reminders for equipment calibration.

13. The method of claim 8, wherein the configurable parameters include one or more audible sounds indicating viewing operations.

14. The method of claim 8, wherein the configurable parameters include one or more foreign languages.

15. A configurable mammography diagnostic system, comprising:
at least one scannable preference form, the scannable preference form displaying at least one user-configurable parameter, wherein the at least one user-configurable parameter is adaptable to be selected by placing a mark on the scannable preference form; and
an arrangement for optically reading at least one mark on the scannable preference form; wherein the diagnostic system is adapted to be configured without the use of a graphical user interface.

16. The system of claim 15, wherein the at least one scannable preference form includes a region for marking, whereby the system indicates a selection by detecting a number of black pixels in the region.

17. The system of claim 15, wherein the at least one scannable preference form includes an outer box and an inner box for marking, whereby the system indicates a selection by detecting a predetermined number of black pixels in the inner box and indicates an erase by detecting a predetermined number of pixels in the outer box.

18. The system of claim 15, wherein the optical reading arrangement includes a computer aided detection module.

19. The system of claim 18, wherein a medical information system is communicatively coupled to the computer aided detection module.

20. A preference report article for use with a mammography diagnostic system, comprising:
one or more optically scannable marking fields displayed on a form adapted to provide user-selectable preferences, wherein the user-selectable preferences are operable to alter hardware and software default settings in the mammography diagnostic system.

21. The preference report article of claim 20, wherein the user-selectable preferences include one or more different mammographic views.

22. The preference report article of claim 20, wherein the user-selectable preferences are sequenced to accommodate a desired order of review.
